(19) United States
(12) Patent Application Publication
(10) Pub. No.: US 2018/0147514 A1
(43) Pub. Date: May 31, 2018

(54) MOTOR VEHICLE HAVING A WATER TANK DESIGNED AS A HEAT EXCHANGER

(71) Applicant: WEIDPLAS GMBH, Kusnacht (CH)

(72) Inventors: Stefan HARKE, Sinsheim (DE); Armin MÜLLER, Kaltbrunn (CH); Piero DAL VECCHIO, Ermenswil (CH)

(73) Assignee: WEIDPLAS GmbH, Kusnacht (CH)

(21) Appl. No.: 15/568,642

(22) PCT Filed: Apr. 19, 2016
(86) PCT No.: PCT/EP2016/058662

§ 371 Date: Oct. 23, 2017

(30) Foreign Application Priority Data
Apr. 24, 2015 (EP) 15164967.0

(51) Int. Cl. B01D 45/08; B60H 1/28; B60H 1/00

(52) U.S. Cl. CPC B01D 45/08; B60H 1/28; B60H 2001/00214; B60H 1/00321; B60H 1/00021

(57) ABSTRACT

The invention relates to a motor vehicle having a water tank (10) with a first inner chamber (23) for separating and conducting away water from a first air flow (15) flowing through the first inner chamber (23). The water tank (10) is designed as a heat exchanger, comprising a heat exchanger element (20) for transferring thermal energy between the first air flow (15) and a second air flow (50). At least one guide structure (8) is provided for guiding the second air flow to the heat exchange element (20) in a targeted manner. In addition, at least one control element (34) is provided, with which the transfer of the thermal energy between the first air flow (15) and the second air flow (50) can be enabled in a first operating state, and can be at least partially inhibited in a second operating state.

### TECHNICAL FIELD

The present invention relates to a motor vehicle having a water tank designed as a heat exchanger, a water tank for such a motor vehicle, and a method for controlling the temperature of such a motor vehicle.

### PRIOR ART

In order to heat or cool the air in the passenger compartment, in motor vehicles it is normal practice for fresh air to be drawn in from the outside and supplied to the passenger compartment by means of an air-conditioning unit. An air-conditioning unit has at least one evaporator and/or one heater by way of which the fresh air can be cooled down or heated to a desired temperature. For the purpose of drawing in air, said unit may additionally include an air-conveying means, such as in particular a fan.

In order that the air-conditioning unit can be provided with fresh air that is, to the greatest possible extent, dry and free of drops, a water tank is usually provided in motor vehicles. The function of the water tank is to separate water out from the drawn-in fresh air such that as few water drops as possible pass into the air-conditioning unit. In particular in the case of rain, water can be contained in the form of splash water or in the form of droplets in the drawn-in fresh air. The provision of a water tank is intended to prevent water drops from settling in the air filter of the air-conditioning device, which can result in unwanted mold formation.

However, the controlling of the temperature, that is to say the heating or the cooling, of the drawn-in air to a desired temperature in the air-conditioning unit requires a significant amount of energy. In the case of electric vehicles and hybrid vehicles, electrical energy has to be supplied for this purpose from the battery or from the accumulator. This can seriously impair the overall energy balance of such motor vehicles.

In order to lower the energy consumption when controlling the temperature of the passenger compartment of a motor vehicle, WO 2013/164260 A1 proposes designing the water tank as a heat exchanger, having a heat exchange element to which waste air is guided in a targeted manner in order to transfer the thermal energy of the waste air to the fresh air flowing through the water tank. The temperature of the drawn-in fresh air can thereby be pre-controlled in the water tank by means of the waste air whose temperature has already been controlled, and a significant energy saving in the air-conditioning unit can therefore be achieved. Further energy savings would be desirable, however.

EP 2 752 318 A1 proposes arranging a first water tank in the interior of a second water tank in order to still ensure a relatively small pressure drop even when large amounts of air are drawn in. Due to the relatively small pressure drop, the energy consumption of the air-conveying means can be lowered.

US 2002/0164942 A1 discloses an air-conditioning unit by way of which it is possible to draw in either fresh air from the outside, or circulating air from a rear region of the passenger compartment, for the purpose of cooling a passenger compartment. A desired operating mode can be selected by means of a flap controller.

### SUMMARY OF THE INVENTION

It is an object of the present invention to further lower the energy consumption in a vehicle having a water tank designed as a heat exchanger. To achieve this object, a motor vehicle as specified in claim 1 is proposed. Furthermore, a water tank for such a motor vehicle is proposed in claim 10, and a method for controlling the temperature of a motor vehicle is proposed in claim 14. Advantageous configurations of the invention are specified in the dependent claims.

The present invention thus provides a motor vehicle having

a water tank with a first inner chamber for separating and removing water from a first air stream flowing through the first inner chamber, wherein the water tank is designed as a heat exchanger and has a heat exchange element which serves for transferring thermal energy between the first air stream and a second air stream; and having

at least one guide structure, which serves for guiding the second air stream to the heat exchange element in a targeted manner.

At least one control element is provided, by way of which the transfer of the thermal energy between the first air stream and the second air stream can be allowed in a first operating state and at least partially, preferably substantially completely, more preferably completely, prevented in a second operating state.

The control element thus serves for switching over from the first operating state to the second operating state, and vice versa. The selection of the operating state preferably takes place in dependence on the temperatures of the first and the second air flow. More preferably, the selection of the operating state takes place in dependence on the temperatures of the exterior air and the air in the passenger compartment. Advantageously, sensors or thermometers for measuring the temperature of the first and the second air flow or of the exterior and the interior temperature are therefore provided.

It has been found that the passenger compartment of a motor vehicle can heat up to very high temperatures, in particular in summer and if the motor vehicle is exposed to the sun, which can be up to 50° C. above the exterior temperature. The fact that in such cases, in particular when starting a journey, the second operating state is now assumed, and the occurrence of a transfer of thermal energy between the first and the second air stream is thus at least partially prevented, means that it is possible to avoid the inflowing fresh air being heated by the overheated interior compartment air of the passenger compartment, in particular prior to said fresh air being cooled down by any evaporator of the motor vehicle, which evaporator is preferably arranged in any air-conditioning unit of the motor vehicle. As a result, the evaporator can be operated with a significantly lower cooling power when starting a journey. Moreover, the desired interior temperature in the passenger compartment can thereby be reached more quickly. As soon as the interior temperature prevailing in the passenger compartment is lower than or the same as the exterior temperature, the first operating state, in which the temperature of the first air stream is pre-controlled with the aid of the second air stream via the heat exchange element, can be assumed by means of the control element.

The second air stream preferably constitutes waste air which is drawn in in particular from the passenger compartment of the motor vehicle. The second air stream does not necessarily have to be used to pre-cool the first air stream, but may of course also be used for pre-heating the first air stream. In particular, in this case, it is also possible for waste air from the engine compartment, for example, to be used for the second air stream. A switchover between the first and the second operating state would then occur in dependence on the interior temperature prevailing in the engine compartment.

The water tank has a wall delimiting the first inner chamber, and at least one air inlet opening through which air, in particular fresh air, can flow into the first inner chamber, and at least one air outlet opening through which air can flow out of the first inner chamber. In order to remove water from the first inner chamber, the water tank preferably has at least one water outlet opening. The water tank may be designed in particular according to one of the embodiments specified in WO 2013/164260 A1, the disclosure of which is hereby included in its entirety in the present application text.

The heat exchange element preferably forms at least one part of the wall which delimits the first inner chamber. More preferably, it even forms a large part of said wall.

Preferably, the heat exchange element has a wall thickness of less than 1 mm, in particular of less than 0.5 mm. As a result, good heat transfer of the heat transfer element can be achieved, irrespective of the material used. Alternatively or additionally, the heat exchange element may also be produced from a highly thermally conductive material, such as in particular metal. However, it is also possible for it to be produced from a plastic, such as in particular polypropylene. If the heat exchange element is produced from polypropylene (PP), it preferably has a content of 20% of talcum. Preferably, a plastic material having a particularly high thermal conductivity of greater than 0.3 W/mK, determined according to EN ISO 22007-2: 2008, is provided.

In order to improve separation of water from the inflowing fresh air, the water tank preferably has a diversion element which projects into the first inner chamber and which is flowed around in the vertical and/or horizontal direction by the inflowing air.

The control element is preferably a shut-off member, in particular a valve, such as for example a shut-off flap or a shut-off slide, by way of which, in the second operating state, it is possible to at least partly, preferably substantially completely, more preferably completely, prevent the second air stream from passing to the heat exchange element. The shut-off member can thus at least partly or even completely prevent the formation of a second air stream, or else divert the second air stream such that it passes to the heat exchange element only partially or not at all. The shut-off member may thus also be formed as a diversion element. Alternatively, albeit less preferably, the control element may serve for example also for diverting the first air stream instead of the second air stream. However, the control element may also be designed for example as an air-conveying means, such as for example a fan. In the case of an air-conveying means, it is possible in the second operating state to partly prevent the second air stream from passing to the heat exchange element in that, for example, the air-conveying means is not or is only weakly in operation and consequently generates high flow resistance.

The motor vehicle preferably has a control unit which is designed for controlling the control element such that the control element allows the transfer of the thermal energy between the first air stream and the second air stream in the first operating state and at least partially prevents it in the second operating state. The control unit comprises for example an actuator, such as for example a motor or an electromagnet, for moving the control element, and also comprises an evaluation unit, such as for example a circuit board, which is connected to the actuator and serves for controlling the actuator. By means of the control unit, it is therefore possible for the control element to be controlled selectively in accordance with the first or the second operating state. In this case, the first operating state is advantageously assumed when the temperature of the second air stream is lower than or the same as the temperature of the first air stream. The second operating state is advantageously assumed when the temperature of the second air stream is higher than that of the first air stream. Even more advantageously, the first operating state is assumed when an interior temperature prevailing in the passenger compartment of the motor vehicle is lower than or the same as an exterior temperature prevailing outside the motor vehicle, and the second operating state is assumed when the interior temperature is higher than the exterior temperature. The control unit is preferably designed to control the control element automatically, that is to say autonomously, in accordance with the first or the second operating state. For this purpose, the control unit is preferably connected to corresponding sensors or thermometers. In this manner, optimal energy efficiency can be ensured.

According to a development of the invention, the motor vehicle has at least one evaporator for cooling down the first air stream. Preferably, the motor vehicle has an air-conditioning unit in which the evaporator is arranged. The motor vehicle preferably has a heating element which serves for heating the first air stream and which is preferably arranged in an air-conditioning unit. Preferably, the first air stream firstly flows to an evaporator, in particular to an evaporator which is arranged in an air-conditioning unit, and then flows into the passenger compartment.

According to a development of the invention, the motor vehicle has at least one air-conveying means, such as for example a fan, for generating the first air stream. The air-conveying means is preferably arranged in an air-conditioning unit of the motor vehicle.

Advantageously, a connecting structure is provided in order, in the second operating state, to guide an additional fresh-air stream, which flows outside the first inner chamber, preferably which flows outside the first inner chamber and comes into contact with the heat exchange element, to the passenger compartment, in particular to the air-conditioning unit. The additional fresh-air stream preferably constitutes fresh air drawn in from the outside, which generally has approximately the same temperature as the drawn-in fresh air of the first air stream. Preferably, the air of the additional fresh-air stream in the second operating state, in comparison with that of the second air stream in the first operating state, flows in an opposite direction, at least in the region of the water tank and, in particular, of the heat exchange element. In the second operating state and in particular when starting a journey, it is often the case that a relatively large amount of air is drawn in through the water tank, for example because of misted windows or in order to cool or heat the passenger compartment. The fact that the additional fresh air of the additional fresh-air stream can be guided to the passenger compartment, in particular to the air-conditioning unit, means that a relatively small pressure drop with regard to the total amount of drawn-in air can still be ensured overall. Any air-conveying means arranged in the air-conditioning unit can thereby be operated with a relatively low energy consumption.

Preferably, at least one regulating element is provided, which is designed in particular as a valve, such as for example a shut-off flap or a shut-off slide, by way of which it is possible to selectively allow or at least partially prevent the passage of the additional fresh-air stream to the passenger compartment, in particular to the air-conditioning unit. However, the regulating element may also be designed for example as an air-conveying means, such as for example a fan, by way of which it is possible to partly prevent the additional fresh-air stream from passing to the passenger compartment, in particular to the air-conditioning unit. If the air-conveying means is not or is only weakly in operation, the air-conveying means generates high flow resistance and partially prevents the additional fresh-air stream from being able to pass to the passenger compartment, in particular to the air-conditioning unit. With the aid of the regulating element, it is thus possible, in particular in the second operating state, to establish whether only air which flows through the first inner chamber of the water tank is drawn in by the air-conditioning unit or passes into the passenger compartment, or whether air which flows outside the first inner chamber, in particular which flows outside the first inner chamber and in this case comes into contact with the heat exchange element, is additionally drawn in.

In a preferred embodiment, the control element at the same time forms the regulating element. The control or regulating element may in this case be designed for example as a valve, such as for example as a diversion flap, at least two shut-off flaps or at least two shut-off slides. However, the control or regulating element may also be designed for example as at least two air-conveying means, such as for example at least two fans. Thus, in the case of the control element being designed as a regulating element, when switching over to the second operating state, firstly thermal energy transfer between the first and the second air stream is at least partially prevented, and secondly an additional fresh-air stream, which comes into contact with the heat exchange element outside the first inner chamber, is simultaneously guided to the passenger compartment, in particular to the air-conditioning unit. Thus, if the control or regulating element is designed as at least two air-conveying means, such as for example at least two fans, when switching over to the second operating state, firstly thermal energy transfer between the first and the second air stream is partially prevented in that a first air-conveying means, in particular a first fan, is not or is only weakly in operation, since the first air-conveying means generates high flow resistance if the first air-conveying means is not or is only weakly in operation, and secondly an additional fresh-air stream, which preferably comes into contact with the heat exchange element outside the first inner chamber, is simultaneously guided to the passenger compartment, in particular to the air-conditioning unit, in that a second air-conveying means, in particular a second fan, is in operation.

According to a development of the invention, the connecting structure is at least one connecting line, in particular a connecting tube. This allows the air of the additional fresh-air stream to flow for example directly into the passenger compartment or to be introduced for example via an evaporator, which is preferably arranged in an air-conditioning unit, into the passenger compartment.

According to a development of the invention, the connecting structure is a connecting opening that opens out into the first inner chamber of the water tank. This allows the air of the additional fresh-air stream to flow directly into the first inner chamber of the water tank, where any water can be separated out and removed from the additional fresh-air stream. Via the first inner chamber, the air of the additional fresh-air stream or of a third air stream can be drawn into the air-conditioning unit by the air-conveying means. In order to ensure as low a pressure drop as possible, with regard to the air-flow direction of the first air flow, the connecting opening advantageously opens out into the first inner chamber downstream from any diversion element projecting into the first inner chamber.

Preferably, the guide structure, which serves for guiding the second air stream to the heat exchange element in a targeted manner, delimits, together with the heat exchange element, a second inner chamber. The heat exchange element is then preferably formed by an inner wall of the water tank, and the guide structure by an outer wall. With the exception of one or more inlet openings, through which the second air stream and, if appropriate, in the second operating state, the abovementioned additional fresh-air stream can flow into the second inner chamber, and of one or more outlet openings, through which the second and, if appropriate, the additional fresh-air stream can flow out of the second inner chamber, the second inner chamber may form a closed space. In order to achieve heat transfer with the highest possible efficiency, the second inner chamber advantageously surrounds the inner wall to a large extent, in particular substantially completely. According to a development of the invention, however, it is also possible to provide a water outlet opening which serves for removing water from the second inner chamber. In this case, two water tanks nested one inside the other are thus present—an inner water tank which contains the first inner chamber and is arranged inside the second inner chamber of an outer water tank.

Also specified according to the invention is a water tank which is designed in particular according to the above statements and has

a first inner chamber for separating and removing water from a first air stream flowing through the first inner chamber; and

a heat exchange element, which serves for transferring thermal energy between the first air stream and a second air stream; and

at least one guide structure, which serves for guiding the second air stream to the heat exchange element in a targeted manner.

The water tank has at least one control element, by way of which the transfer of the thermal energy between the first air stream and the second air stream can be allowed in a first operating state and at least partially prevented in a second operating state.

Provided according to a development of the invention are an insulation layer and/or a heat-reflecting foil, which surrounds the first and, if present, the second inner chamber to a large extent, in particular substantially completely. The insulation layer is preferably produced from a material having a thermal conductivity of less than 0.1 W/mK, determined according to the standard EN ISO 22007-2: 2008. The heat-reflecting foil preferably has an emission coefficient of less than 0.6, determined according to the standard VDI/VDE 3511-4: 1995. The water tank is thereby particularly well sealed off in terms of energy from the surroundings, in particular the engine compartment.

Also specified according to the invention is a method for controlling the temperature of a motor vehicle, in particular a passenger compartment of a motor vehicle, which is designed in particular according to the above statements and has a water tank which, according to the above specifications, is designed as a heat exchanger. According to this method, in a first operating state, a second air stream is guided to the heat exchange element of the water tank in a targeted manner in order thereby to allow transfer of the thermal energy between a first air stream, flowing through the water tank, and the second air stream. In a second operating state, the transfer of the thermal energy between the first air stream and the second air stream is at least partially, in particular completely, prevented.

In order to allow optimum energy efficiency, in the method according to the invention, the first operating state is advantageously assumed when an interior temperature prevailing in a passenger compartment of the motor vehicle is lower than or the same as an exterior temperature prevailing outside the motor vehicle, and the second operating state is assumed when the interior temperature is higher than the exterior temperature.

### BRIEF DESCRIPTION OF THE DRAWINGS

Preferred embodiments of the invention will be described below on the basis of the drawings, which serve merely for explanation and are not to be interpreted as being limiting. In the drawings:

FIG. 1 shows a central sectional view through a water tank, designed as a heat exchanger, of a motor vehicle according to the prior art;

FIG. 2 shows a central sectional view through a water tank of a first motor vehicle according to the invention;

FIG. 3a shows a central sectional view through a water tank of a second motor vehicle according to the invention, in a first operating state;

FIG. 3b shows a central sectional view through the water tank shown in FIG. 3a, in a second operating state;

FIG. 4 shows a sectional view through a schematically illustrated, third motor vehicle according to the invention;

FIG. 5a shows a central sectional view through a water tank, and through an air-conditioning unit connected thereto, of a fourth motor vehicle according to the invention, in a first operating state;

FIG. 5b shows a central sectional view through the water tank, and through the air-conditioning unit connected thereto, of the motor vehicle shown in FIG. 5a, in a second operating state;

FIG. 6 shows a central sectional view through a water tank, and through an air-conditioning unit connected thereto, of a fifth motor vehicle according to the invention;

FIG. 7 shows a central sectional view through a water tank, and through an air-conditioning unit connected thereto, of a sixth motor vehicle according to the invention;

FIG. 8 shows a central sectional view through a water tank, and through an air-conditioning unit connected thereto, of a seventh motor vehicle according to the invention;

FIG. 9a shows a central sectional view through a water tank, and through an air-conditioning unit connected thereto, of an eighth motor vehicle according to the invention, in a first operating state;

FIG. 9b shows a central sectional view through the water tank shown in FIG. 9a, and through the air-conditioning unit connected thereto, in a second operating state;

FIG. 10 shows a central sectional view through a water tank, and through an air-conditioning unit connected thereto, of a ninth motor vehicle according to the invention;

FIG. 11 shows a central sectional view through a water tank, and through an air-conditioning unit connected thereto, of a tenth motor vehicle according to the invention;

FIG. 12a shows a central sectional view through a schematically illustrated, eleventh motor vehicle according to the invention, in a first operating state; and

FIG. 12b shows a central sectional view through the motor vehicle shown in FIG. 12a, in a second operating state.

### DESCRIPTION OF PREFERRED EMBODIMENTS

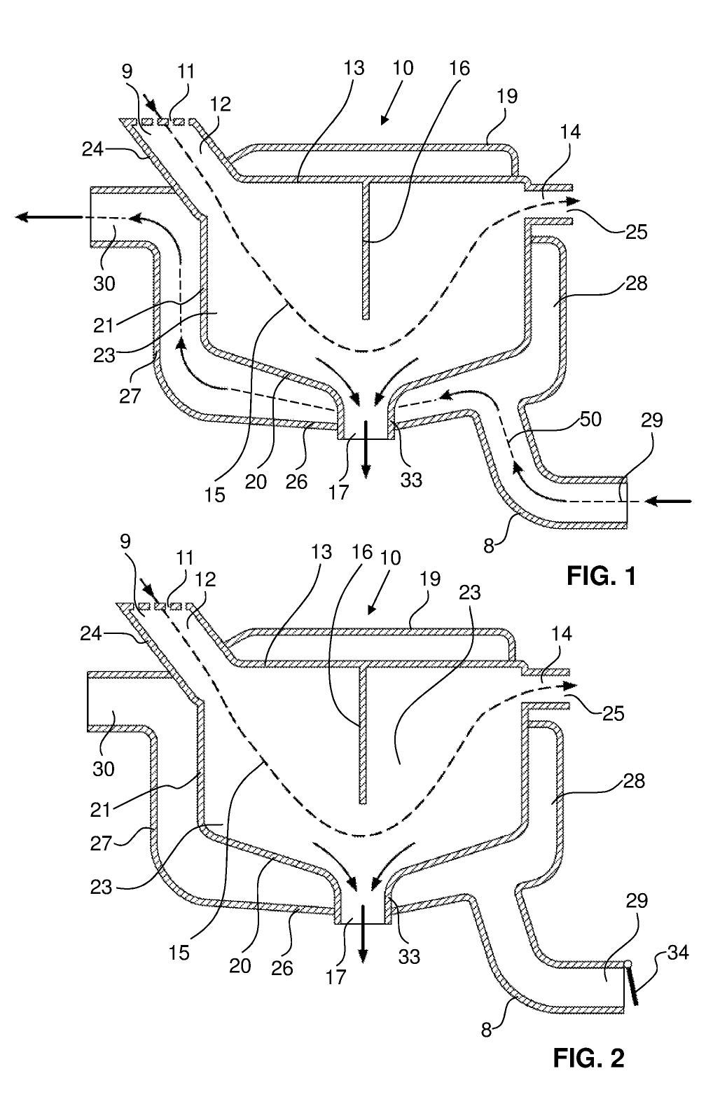

For the embodiments described below and shown in FIGS. 1 to 12b, in each case the same reference signs are used for identically or similarly formed elements which perform an identical or similar function.

Locational and directional indications such as top, bottom, vertical, horizontal, upward, downward, etc. relate below in each case to the motor vehicle 1, or the water tank 10 installed therein, in their normal, intended position according to the orientation shown in FIGS. 1 to 12b. In the case of the intended water tank 10 installed in a motor vehicle 1, the air inlet opening 9 and advantageously also the air outlet opening 25 are preferably arranged above the water outlet opening 17.

In FIG. 1, a water tank 10, designed as a heat exchanger, of a motor vehicle 1 according to the prior art is shown. The water tank 10 forms a hollow body with an inner side wall 21 which extends upward from an inner bottom wall 20 in an encircling manner. The inner side wall 21 and the inner bottom wall 20 delimit, together with an inner top wall 13, a first inner chamber 23. The inner side wall 21 is of substantially hollow cylindrical form, and it can widen slightly in an upward direction. The inner bottom wall 20 is of funnel-shaped form, and widens from the bottom up. At its lowest point, the inner bottom wall 20 has a centrally arranged water outlet opening 17 which is delimited laterally in an encircling manner by the inner surface of a drain tube 33 which extends downward from the inner bottom wall 20.

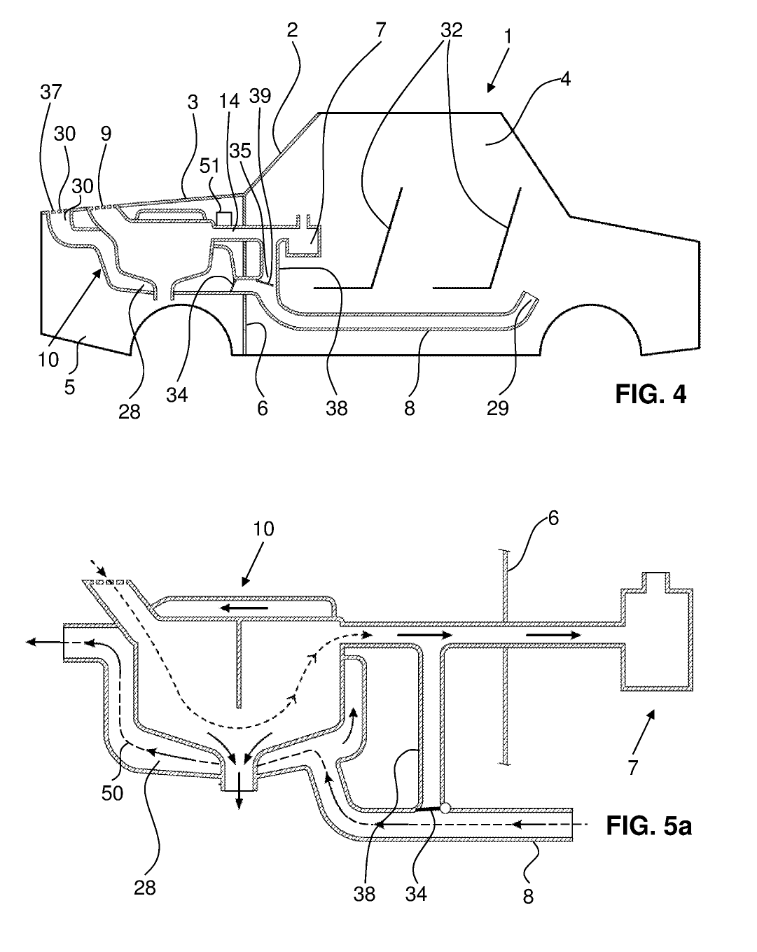

In the crossover region between the inner top wall 13 and the inner side wall 21 there is provided a supply line 24 which forms an inlet channel 12. Said inlet channel 12 connects the air inlet opening 9, through which fresh air outside the motor vehicle is able to be drawn in, to the first inner chamber 23 of the water tank 10. A discharge line, which forms an air channel 14, is provided diametrically opposite the supply line 24 in the upper region of the inner side wall 21. The air channel 14 passes through the end wall 6 of the motor vehicle 1 (see FIG. 4) and opens out into an air outlet opening 25. Fresh air can therefore be drawn in through the air inlet opening 9 by an air-conditioning unit 7 through the first inner chamber 23 of the water tank 10, which air is passed on from the air-conditioning unit 7 into the passenger compartment 4 of a motor vehicle (see for example FIG. 4). The fresh air drawn in through the first inner chamber 23 forms a first air stream 15.

Above the water outlet opening 17, a diversion element 16 is fitted to the inner top wall 13 and extends in a vertical direction from the inner top wall 13 into the first inner chamber 23. Here, the diversion element 16 extends in the vertical direction slightly less far than the inner side wall 21. In the horizontal direction, the diversion element 16 extends over the inner top wall 13 in a diametrical direction, perpendicularly to an imaginary straight line which connects to one another the mouths of the inlet channel 12 and of the air channel 14 into the first inner chamber 23.

A grille 11 may be provided in the region of the air inlet opening 9 in order to prevent unwanted constituents contained in the splash water from entering the supply line 24 and thus into the first inner chamber 23. This is intended in particular to prevent snow and foliage from entering.

The air outlet opening 25 opens out into the air-conditioning unit 7 which has an air-conveying means in the form of a fan 18 (see for example FIG. 8). The air-conditioning unit 7 also comprises an evaporator and/or a heating element, which are both not illustrated in the figures, however. The air-conditioning unit 7 also has an air outlet 22 which opens out into the passenger compartment 4 of the motor vehicle 1.

As indicated in FIG. 1 by dashed lines, the fresh air, which forms a first air stream 15, is drawn in through the inlet opening 9 by means of the fan 18 and passes through the inlet channel 12 into the first inner chamber 23 of the water tank 10. In the first inner chamber 23, the drop-containing fresh air flows around the diversion element 16, which could in principle also be designed such that it is flowed around horizontally by the first air stream 15. Water drops which are contained in the drawn-in fresh air are separated out at the diversion element 16, collected by the inner bottom wall 20 and then pass downward into the water outlet opening 17. The separated water exits the water tank 10 in a downward direction through the water outlet opening 17. The first air stream 15, which is largely free of water drops, then passes via the air channel 14 into the air-conditioning unit 7, where the air can be heated or cooled down. From the inside of the air-conditioning unit, the first air stream 15 then passes through the air outlet 22 into the passenger compartment 4.

In order now to pre-control the temperature of the fresh air, drawn in by the air-conditioning unit 7, of the first air stream 15 and thereby to reduce the energy consumption of the air-conditioning unit 7, the water tank 10 is designed as a heat exchanger, wherein the inner walls 13, 20 and 21 together form a heat exchange element. Moreover, the water tank 10 has guide structures which serve for guiding waste air from the passenger compartment 4 to said heat exchange element in a targeted manner. For this purpose, the water tank 10 has an outer side wall 27 which is of substantially hollow cylindrical form and is arranged in an encircling manner around the inner side wall 21. At its lower end, the outer side wall 27 merges into an outer bottom wall 26 which substantially completely covers the inner bottom wall 20 in the downward direction. The outer bottom wall 26 has a central opening through which the drain tube 33 extends. At its upper end, the outer side wall 27 merges into an outer top wall 19 which substantially completely covers the inner top wall 13 in the upward direction.

The outer side wall 27, the outer bottom wall 26 and the outer top wall 19 delimit, together with the inner side wall 21, the inner bottom wall 20 and the inner top wall 13, a second inner chamber 28, which surrounds the inner side wall 21 and covers the inner bottom wall 20 and the inner top wall 13. Part of the second inner chamber 28 thus forms an encircling annular space in the region of the inner side wall 21.

In the region of the outer bottom wall 26, an intake line 8, which opens out from below into the second inner chamber 28, is provided in a region facing the end wall 6. The intake line has a waste-air inlet opening 29 which may be arranged in the passenger compartment 4 or in the engine compartment 5. In the case where the waste-air inlet opening 29 is arranged in the engine compartment 5, it is possible to connect the intake line 8 to a further line which extends through the end wall 6 into the passenger compartment 4. On that side of the water tank 10 which is remote from the end wall 6, a waste-air outlet opening 30 is provided in an upper region of the outer side wall 27. Said waste-air outlet opening 30 is arranged spatially diagonally opposite the intake line 8 in relation to the second inner chamber 28 such that, in the second inner chamber 28, an air flow from the intake line 8 to the waste-air outlet opening 30 can form, which surrounds the first inner chamber 23 over a maximum area.

When operating the air-conditioning unit 7, waste air is therefore guided from the passenger compartment 4 through the intake line 8 into the second inner chamber 28 of the water tank 10. The waste air, whose temperature has already been controlled, forms a second air stream 50 which, in the second inner chamber 28, flows around the inner bottom wall 20, the inner top wall 13 and the inner side wall 21, whereby the temperature of the second air stream 50 is transferred to the fresh air, flowing through the first inner chamber 23, of the first air stream 15. This results in the temperature of the fresh air that is present in the first inner chamber 23 being pre-controlled. The waste air guided through the intake line 8 thus flows around substantially all the walls delimiting the first inner chamber 23. The waste air of the second air stream 50 then exits the water tank 10 in an outward direction via the waste-air outlet opening 30.

In order to allow efficient transfer of the thermal energy between the first air stream 15 and the second air stream 50, it is possible for heat exchange structures to be present on the inside in the first inner chamber 23 on the inner side wall 21 and/or on the inner top wall 13 and/or on the inner bottom wall 20, and/or on the outside in the second inner chamber 28, for the purpose of enlarging the respective surfaces. These may be for example ribs, grooves, projections or other structures which are well known to a person skilled in the art and are correspondingly suitable for this purpose. It is in particular preferable for the inner side wall 21 and/or the inner top wall 13 and/or the inner bottom wall 20 to be at least partially of corrugated form.

A first embodiment of a motor vehicle according to the invention having a water tank 10 is shown in FIG. 2. In comparison with the water tank 10 shown in FIG. 1, a control element in the form of a shut-off flap 34 is provided here, which is fitted to the intake line 8 in the region of the waste-air inlet opening 29 and serves for closing the waste-air inlet opening 29. By means of the shut-off flap 34, it is thus possible to partially or completely prevent the waste air of the second air stream 50 from passing into the second inner chamber 28.

The inner walls 13, 20 and 21 together form the heat exchange element. Preferably, the heat exchange element has a wall thickness of less than 1 mm, in particular of less than 0.5 mm. As a result, good heat transfer of the heat transfer element can be achieved, irrespective of the material used. Alternatively or additionally, the heat exchange element may also be produced from a highly thermally conductive material, such as in particular metal. However, it is also possible for it to be produced from a plastic, such as in particular polypropylene. If the heat exchange element is produced from polypropylene (PP), it preferably has a content of 20% of talcum. Preferably, a plastic material having a particularly high thermal conductivity is provided. For example, it is also possible for only one of the mentioned walls 13, 20 and 21 to form the heat exchange element, or two of the mentioned walls 13, 20 and 21 may together form the heat exchange element. Also, it goes without saying that only partial regions of the walls 13, 20 and 21 may be involved in the formation of the heat exchange element.

In a first operating state, when the interior temperature prevailing in the passenger compartment 4 of the motor vehicle 1 is lower than or the same as an exterior temperature prevailing outside the motor vehicle 1, the shut-off flap 34 is open, and so it is possible for waste air to flow from the passenger compartment 4 into the second inner chamber 28 and to pre-cool via the inner bottom wall 20, the inner side wall 21 and the inner top wall 13 the first air flow 15 flowing through the first inner chamber 23. By contrast, after the motor vehicle 1 has been at a standstill for an extensive period, when the interior temperature prevailing in the passenger compartment 4 is higher than the exterior temperature due to being heated by the sun and thus higher than the temperature of the inflowing fresh air of the first air stream 15, a second operating state is assumed in which the shut-off flap 34 is closed with the result that an inflow of the heated waste air from the passenger compartment 4 into the second inner chamber 28 is prevented. Transfer of thermal energy from the second air stream 50 to the first air stream 15 is thus prevented in the second operating state. Consequently, optimum energy efficiency can be ensured by means of such control of the shut-off flap 34 in the first or second operating state. Instead of a valve, such as for example the shut-off flap 34, the control element may also be designed for example as a shut-off slide (not shown in the figure) or else as an air-conveying means (not shown in the figure), such as for example a fan. In the case of an air-conveying means, it is possible in the second operating state to partly prevent the second air stream from passing to the heat exchange element, in particular if the air-conveying means is not or is only weakly in operation, since the air-conveying means generates high flow resistance if the air-conveying means is not or is only weakly in operation. Valves, such as for example a shut-off slide, and air-conveying means, such as for example a fan, are known to a person skilled in the art.

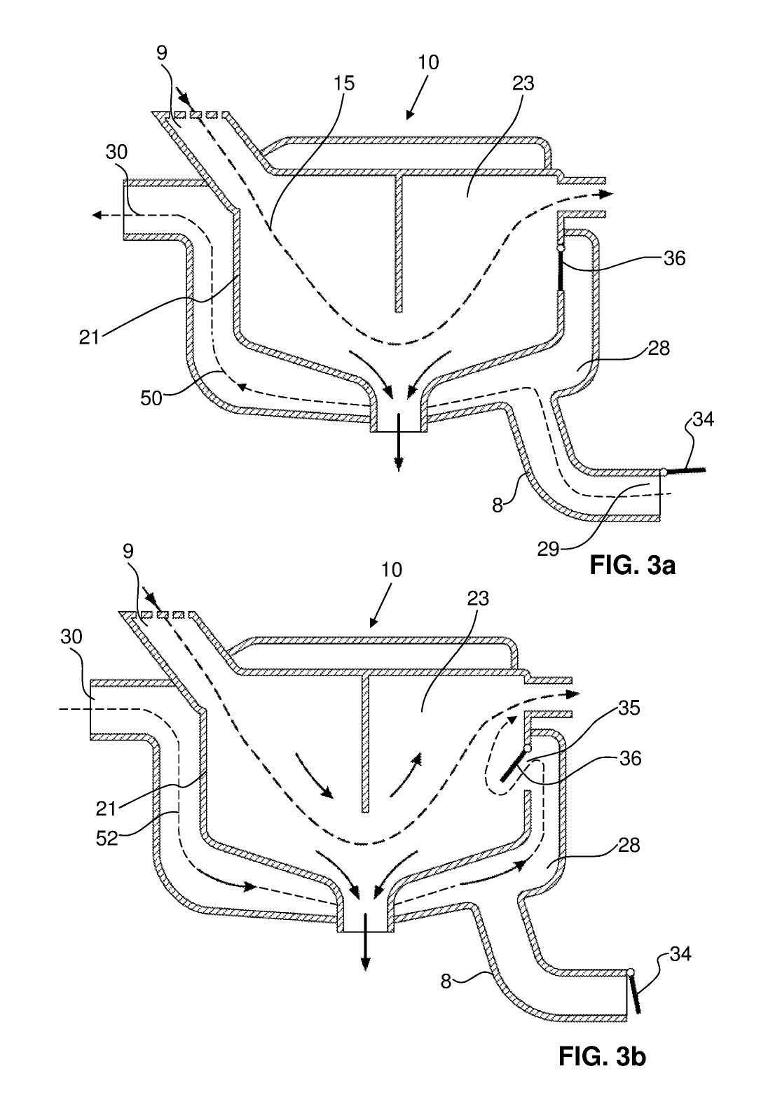

The water tank 10 shown in FIGS. 3a and 3b additionally has, in comparison with the water tank in FIG. 2, a connecting opening 35 which is closable by way of a regulating element in the form of a second shut-off flap 36. Instead of a valve, such as for example the shut-off flap 36, the regulating element may also be designed for example as a shut-off slide (not shown in the figure). The connecting opening 35 is arranged inside the inner side wall 21 on the same side of the water tank 10 as the intake line 8.

In the first operating state, when the interior temperature in the passenger compartment 4 is lower than or the same as the exterior temperature, the first shut-off flap 34 is open, and the second shut-off flap 36 closes the connecting opening 35. As it is shown in FIG. 3a, the second air stream 50 then passes through the waste-air inlet opening 29 into the second inner chamber 28 and via the waste-air inlet opening 30 to the outside. In the second operating state shown in FIG. 3b, the interior temperature, for example when starting a journey, is higher than the exterior temperature, the first shut-off flap 34 is closed, and the second shut-off flap 36 is open. This allows the air-conditioning unit 7 to additionally draw in fresh air from the waste-air outlet opening 30 into the second inner chamber 28, and from there through the connecting opening 35 into the first inner chamber 23, and guide said air into the passenger compartment 4. If an increased air throughput is desirable, for example in the case of a high interior temperature or in the case of misted windows, it is therefore possible, by the connecting opening 35 being opened, for an additional fresh-air stream 52 with fresh air to pass into the air-conditioning unit and into the passenger compartment 4, without the pressure drop between the air inlet opening 9 and the air-conditioning device 7 being increased because of the increased total amount of air drawn in.

The connecting opening 35 does not necessarily have to open out into the first inner chamber 23 of the water tank 10, but may also, as it is shown in the embodiment in FIG. 4, open out into a connecting line 38 which, for its part, opens out into the air channel 14 which connects the water tank 10 and the air-conditioning unit 7 to one another.

The connecting opening 35 is in this case closable by means of a second shut-off flap 39 which, in the direction of the second air stream 50 (when the first shut-off flap 34 is open and when the second shut-off flap 39 is closed), is arranged upstream in relation to the first shut-off flap 34 in the intake line 8. In the embodiment shown in FIG. 4, this arrangement makes it possible in particular in the second operating state when starting a journey to cool the passenger compartment interior air via a circulating-air circuit through the lines 8 and 38, while fresh exterior air simultaneously flows in through the air-inlet opening 9 and the water tank 10. The cooling of the air in the passenger compartment 4 is consequently sped up. The interior climate and the cooling process can be significantly influenced by means of the second shut-off flap 39 which forms a regulating element.

FIG. 4 also serves for illustrating the arrangement of the water tank 10 beneath the engine hood 3 in the engine compartment 5 of the vehicle 1. The air-conditioning unit 7 is normally arranged in the region of the dashboard beneath a windshield 2 of the motor vehicle 1. An end wall 6, which separates the engine compartment 5 from the passenger compartment 4, is in this case passed through by the air channel 14 and the intake line 8. The waste-air outlet opening 30 opens out to the outside in the region of the engine hood 3 and is closed by way of a grille 37.

In the embodiment shown in FIG. 4, the waste-air inlet opening 29 of the intake line 8 is arranged in a rear region of the motor vehicle 1 and, in particular, behind the passenger seats 32. In this way, optimum air circulation in the passenger compartment 4 can be achieved.

In an alternative embodiment, the first shut-off flap 34 shown in FIG. 4 could also be omitted if the second shut-off flap 39 were to serve both for closing the second inner chamber 28 with respect to the intake line 8 and for closing the connecting opening 35. The second shut-off flap 39 would then therefore also take over the function of the first shut-off flap 34.

FIG. 4 also schematically shows a control unit 51 which is arranged here in the engine compartment 5 but could of course also be accommodated in the passenger compartment 4.

The control unit 51 has for example an actuator, such as for example a motor or an electromagnet (not shown in the figure), and an evaluation unit, such as for example a circuit board (not shown in the figure), which is connected to the actuator, and is connected to sensors in the form of thermometers (not shown in the figure) which serve for measuring the temperatures prevailing in the passenger compartment 4 and outside the motor vehicle 1. In dependence on the data received by these sensors, the control unit 51 controls the shut-off flaps 34 and 39 according to the first or the second operating state in order to bring these to a corresponding flap position.

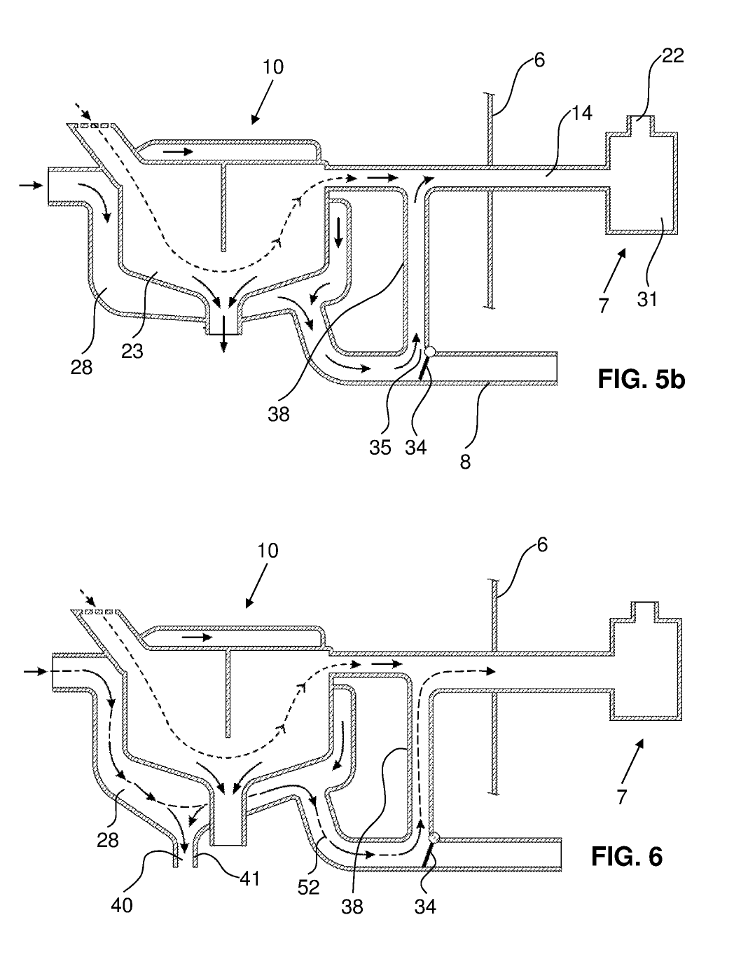

By contrast with the embodiment in FIG. 4, in the embodiment shown in FIGS. 5a and 5b, the connecting line 38 opens out into the intake line 8 downstream in relation to the pivot point of the first shut-off flap 34 in the direction of the second air stream 50 (FIG. 5a). Furthermore here, the connecting line 38 is arranged in the engine compartment 5, as is indicated in FIGS. 5a and 5a by way of the end wall 6.

Here, the shut-off flap 34 forms both a control element for preventing waste air from being able to pass from the intake line 8 into the second inner chamber 28 in the second operating state (FIG. 5b), and a regulating element in order, likewise in the second operating state, to allow an air flow from the second inner chamber 28 into the connecting line 38 via the connecting opening 35 in order that additional fresh air can pass from the outside through the second inner chamber 28 and the air channel 14 to the air-conditioning unit 7. The shut-off flap 34 is therefore designed as a diversion flap. Instead of the shut-off flap 34, which acts both as a control element and a regulating element, it is also possible for at least two shut-off flaps (not shown in figure), at least two shut-off slides (not shown in figure) or at least two air-conveying means (not shown in figure), such as for example two fans, to be provided, which in each case jointly perform the function of both the control element and the regulating element.

The embodiment shown in FIG. 6 is identical to the embodiment in FIGS. 5a and 5b with the exception that here the water tank 10 additionally has a water outlet opening 40 which is surrounded by a drain tube 41 and which serves for removing water from the second inner chamber 28. In the second operating state, in which an additional fresh-air stream 52 passes through the second inner chamber 28 to the air-conditioning unit 7, it is thereby possible for water which is separated from the additional fresh-air stream 52 in the second inner chamber 28 to be removed to the outside.

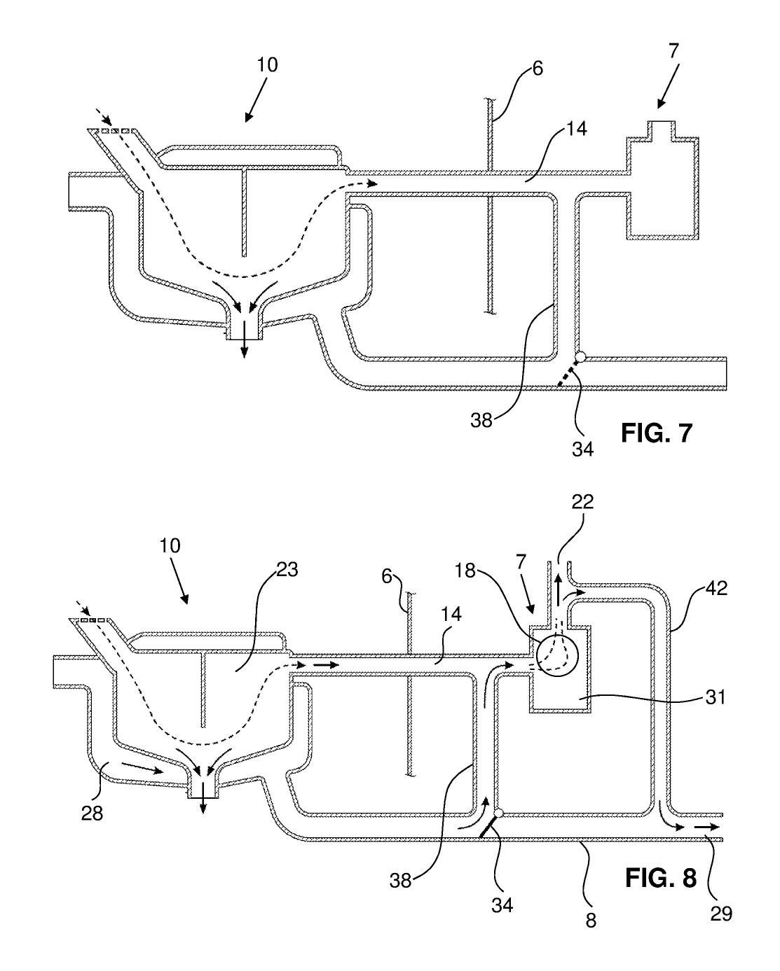

By contrast with FIGS. 5a and 5b, in the embodiment shown in FIG. 7, the connecting line 38 is arranged in the passenger compartment 4 instead of in the engine compartment 5.

In the embodiment shown in FIG. 8, which is otherwise identical to the embodiment in FIG. 7, an additional distribution line 42 is provided, by way of which at least part of the air that has been subjected to temperature controlling can be guided from the air-conditioning unit 7 into the intake line 8, and from there into the passenger compartment 4 via the waste-air inlet opening 29. In the second operating state, that is to say when fresh air is drawn in both through the first inner chamber 23 and through the second inner chamber 28 by means of a fan 18 arranged in the inner chamber 31 of the air-conditioning unit 7, it is thereby possible for the intake line 8 to be used in order to allow fresh air that has been subjected to temperature controlling to additionally flow into the passenger compartment 4, for example in a rear region of the motor vehicle 1.

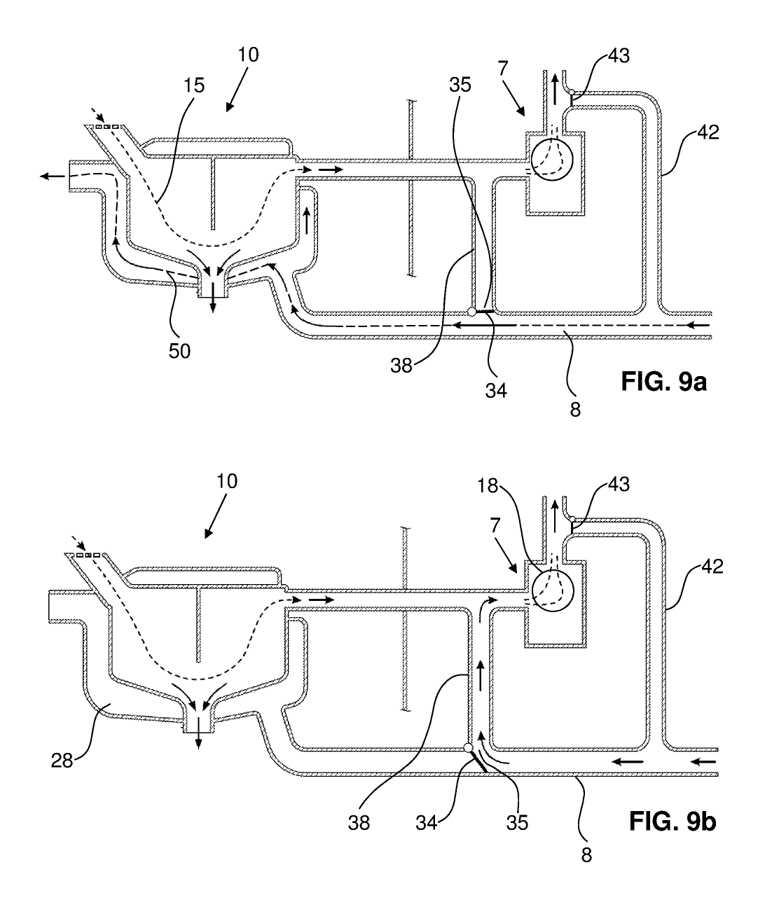

In the embodiment shown in FIGS. 9a and 9b, the distribution line 42 is closable by means of a first shut-off flap 34. Furthermore, this embodiment differs from the embodiment shown in FIG. 8 in that the pivot point of the first shut-off flap 34 is arranged downstream of the connecting opening 35 in the direction of the second air stream 50 (FIG. 9a). Consequently, in the second operating state shown in FIG. 9b, the first shut-off flap 34 serves not only for closing the second inner chamber 28 with respect to the intake line 8, but at the same time also for opening the connecting opening 35 with respect to the intake line 8. This makes it possible to draw in air from a rear region of the passenger compartment 4 into the air-conditioning unit 7 in a circulating-air circuit in the second operating state.

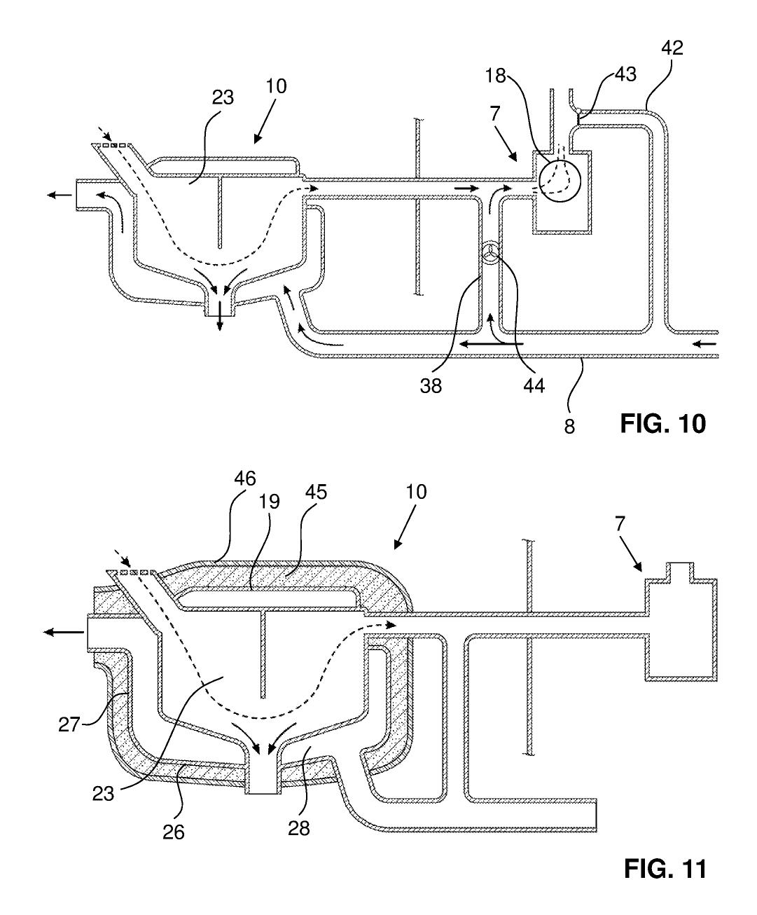

In the embodiment shown in FIG. 10, in which the first shut-off flap is present but is not visible, there is additionally provided a blower 44 inside the connecting line 38. The blower 44 can be operated at a lower conveying power than the fan 18 of the air-conditioning unit 7 in order thereby, in the first operating state, to maintain a continuous circulating-air circuit while fresh air which has been subjected to temperature controlling is at the same time drawn in through the first inner chamber 23.

The water tank shown in FIG. 11 has insulation 45 and a reflecting foil 46, which are arranged around the outer top wall 19, the outer bottom wall 26 and the outer side wall 27, and largely enclose these. The material of the insulation 45 has a thermal conductivity of less than 0.1 W/mK, determined according to the standard EN ISO 22007-2: 2008, and the heat-reflecting foil 46 has an emission coefficient of less than 0.6, determined according to the standard VDI/VDE 3511-4: 1995. As a result, the water tank 10 is, from a heat aspect, optimally shielded from its surroundings and in particular the engine compartment 5. As can be seen in FIG. 11, the insulation 45 and the reflecting foil 46 each surround a first inner chamber 23 and a second inner chamber 28.

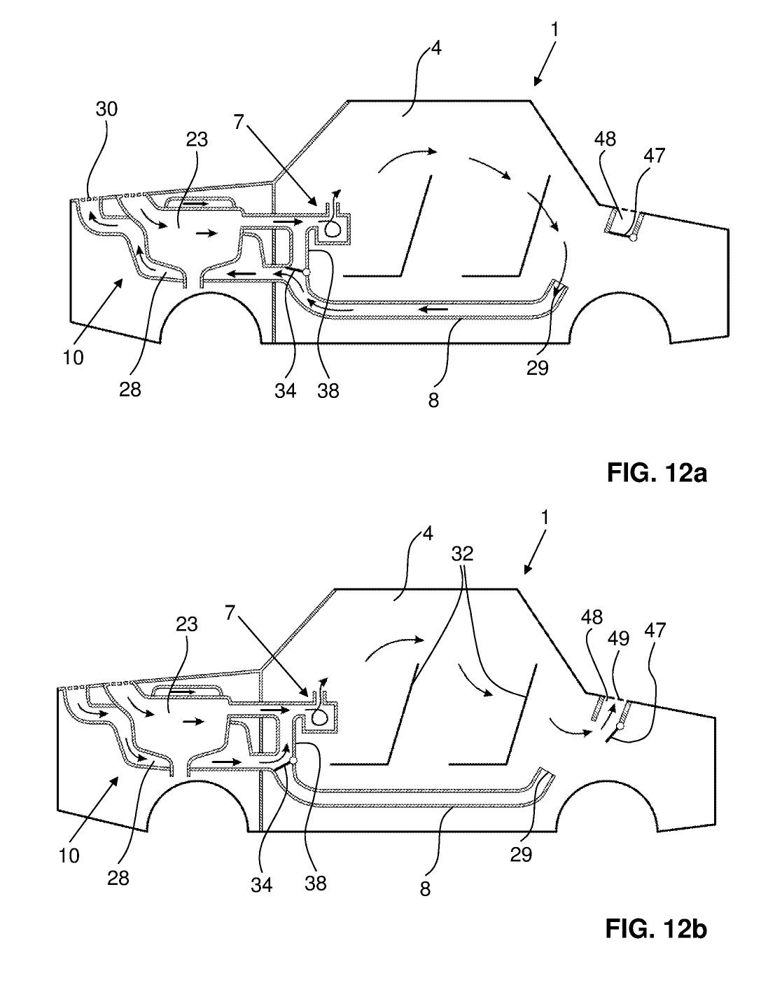

In the embodiment shown in FIGS. 12a and 12b, it is possible in the first operating state (FIG. 12a), when the shut-off flap 34 opens the passage between the intake line 8 and the second inner chamber 28, for air to be supplied via the waste-air inlet opening 29 arranged in a rear region of the passenger compartment 4 to the second inner chamber 28 in order thereby to pre-controlled the temperature of the fresh air flowing in through the first inner chamber 23. This results here in an air flow through the first inner chamber 23 and the air-conditioning unit 7 into the passenger compartment 4, and from said passenger compartment via the intake line 8 into the second inner chamber 28 and via the waste-air outlet opening 30 back to the outside. In the second operating state (FIG. 12b), when the shut-off flap 34 closes the passage from the intake line 8 to the second inner chamber 28 but simultaneously allows fresh air flowing in through the second inner chamber 28 to pass to the air-conditioning unit 7, a waste-air flap 47 arranged in the rear region of the passenger compartment 4 is opened. This allows the air flowing in through the first and the second inner chamber, 23 and 28, to re-exit the passenger compartment 4 through a waste-air opening 48 which is covered by a grille 49. In the passenger compartment 4, this results in an air flow from the air-conditioning unit 7 along the passenger seats 32 to the waste-air opening 48.

It goes without saying that the invention described here is not restricted to the embodiments mentioned and that a large number of modifications are possible. Thus, for example, the water tank 10 does not necessarily have to have a second inner chamber 28. Instead of outside the first inner chamber, the second inner chamber could also be arranged inside the first inner chamber and be surrounded by this. A line that is winding or of any desired form, through which the second air stream 50 flows, could be provided for example in the first inner chamber 23. Said winding line would then form the heat exchange element. Instead of the second air stream 50, it would be possible, by means of a corresponding control element, for the first air stream 15 to be diverted too, in order to prevent transfer of thermal energy between the first air stream 15 and the second air stream 50 in the second operating state. Moreover, additional air-conveying means, such as in particular fans, may be provided in order also to drive forward for example the second air stream 50 and/or the additional fresh-air stream 52. The different elements of the embodiments shown in FIGS. 1 to 12b may also, of course, be combined with one another as desired. A large number of further modifications is conceivable.

LIFT OF REFERENCE SIGNS

| | |
|---|---|
| 1 | Motor vehicle |
| 2 | Windshield |
| 3 | Engine hood |
| 4 | Passenger compartment |
| 5 | Engine compartment |
| 6 | End wall |
| 7 | Air-conditioning unit |
| 8 | Intake line |
| 9 | Air inlet opening |
| 10 | Water tank |
| 11 | Grille |
| 12 | Inlet channel |
| 13 | Inner top wall |
| 14 | Air channel |
| 15 | Air stream |
| 16 | Diversion element |
| 17 | Water outlet opening |
| 18 | Fan |
| 19 | Outer top wall |
| 20 | Inner bottom wall |
| 21 | Inner side wall |
| 22 | Air outlet |
| 23 | First inner chamber |
| 24 | Supply line |
| 25 | Air outlet opening |
| 26 | Outer bottom wall |
| 27 | Outer side wall |
| 28 | Second inner chamber |
| 29 | Waste-air inlet opening |
| 30 | Waste-air outlet opening |
| 31 | Inner chamber |
| 32 | Passenger seat |
| 33 | Drain tube |
| 34 | Shut-off flap |
| 35 | Connecting opening |
| 36 | Shut-off flap |
| 37 | Grille |
| 38 | Connecting line |
| 39 | Shut-off flap |
| 40 | Water outlet opening |
| 41 | Drain tube |
| 42 | Distribution line |
| 43 | Shut-off flap |
| 44 | Blower |
| 45 | Insulation |
| 46 | Reflecting foil |
| 47 | Waste-air flap |
| 48 | Waste-air opening |
| 49 | Grille |
| 50 | Air stream |
| 51 | Control unit |
| 52 | Additional fresh-air stream |

1. A motor vehicle, comprising
a water tank with a first inner chamber for separating and removing water from a first air stream flowing through the first inner chamber, wherein the water tank is designed as a heat exchanger and has a heat exchange element which serves for transferring thermal energy between the first air stream and a second air stream; and
at least one guide structure, which serves for guiding the second air stream to the heat exchange element in a targeted manner;
wherein at least one control element is provided, by way of which the transfer of the thermal energy between the first air stream and the second air stream can be allowed in a first operating state and at least partially prevented in a second operating state.

2. The motor vehicle as claimed in claim 1, wherein the control element is a shut-off member, by way of which, in the second operating state, it is possible to at least partly prevent the second air stream from passing to the heat exchange element.

3. The motor vehicle as claimed in claim 1, wherein a control unit is provided which is designed for controlling the control element such that the control element allows the transfer of the thermal energy between the first air stream; and the second air stream in the first operating state and at least partially prevents it in the second operating state, wherein the first operating state is assumed when an interior temperature prevailing in a passenger compartment of the motor vehicle is lower than or the same as an exterior temperature prevailing outside the motor vehicle, and the second operating state is assumed when the interior temperature is higher than the exterior temperature.

4. The motor vehicle as claimed in claim 1, additionally comprising an air-conditioning unit for at least one of cooling and/or heating the first air stream, wherein a connecting structure is also provided in order, in the second operating state, to guide an additional fresh-air stream to the air-conditioning unit.

5. The motor vehicle as claimed in claim 4, wherein at least one regulating element is provided, by way of which the passage of the additional fresh-air stream to the air-conditioning unit can be selectively allowed or at least partially prevented.

6. The motor vehicle as claimed in claim 5, wherein the control element at the same time forms the regulating element.

7. The motor vehicle as claimed in claim 4, wherein the connecting structure is a connecting opening that opens out into the first inner chamber.

8. The motor vehicle as claimed in claim 1, wherein the guide structure delimits, together with the heat exchange element, a second inner chamber through which the second air stream is able to flow in the first operating state.

9. The motor vehicle as claimed in claim 8, wherein a water outlet opening is provided which serves for removing water from the second inner chamber.

10. A water tank, comprising
a first inner chamber for separating and removing water from a first air stream flowing through the first inner chamber;
a heat exchange element, which serves for transferring thermal energy between the first air stream and a second air stream; and
at least one guide structure, which serves for guiding the second air stream to the heat exchange element in a targeted manner;
wherein the water tank comprises at least one control element, by way of which the transfer of the thermal energy between the first air stream and the second air stream can be allowed in a first operating state and at least partially prevented in a second operating state.

11. The water tank as claimed in claim 10, additionally comprising an inner wall which delimits the first inner chamber, and an outer wall which delimits, together with the inner wall, a second inner chamber through which the second air stream can flow in the first operating state.

12. The water tank as claimed in claim 11, wherein the second inner chamber surrounds the inner wall to a large extent.

13. The water tank claim 10, wherein there is provided at least one of an insulation layer having a thermal conductivity of less than 0.1 W/mK, determined according to the standard EN ISO 22007-2: 2008, and/or a heat-reflecting foil having an emission coefficient of less than 0.6, determined according to the standard VDI/VDE 3511: 1995, which surrounds the first inner chamber to a large extent.

14. A method for controlling the temperature of a motor vehicle having a water tank for separating and removing water from a first air stream flowing through the water tank, wherein the water tank is designed as a heat exchanger and has a heat exchange element which serves for transferring thermal energy between the first air stream and a second air stream,
wherein, in a first operating state, the second air stream is guided to the heat exchange element in a targeted manner in order thereby to allow transfer of the thermal energy between the first air stream and the second air stream,
and wherein, in a second operating state, the transfer of the thermal energy between the first air stream and the second air stream is at least partially prevented.

15. The method as claimed in claim 14, wherein the first operating state is assumed when an interior temperature prevailing in a passenger compartment of the motor vehicle is lower than or the same as an exterior temperature prevailing outside the motor vehicle, and wherein the second operating state is assumed when the interior temperature is higher than the exterior temperature.

16. The motor vehicle as claimed in claim 2, wherein the control element is a shut-off flap.

17. The motor vehicle as claimed in claim 4, wherein the additional fresh-air stream comes into contact with the heat exchange element outside the first inner chamber.

18. The motor vehicle as claimed in claim 5, wherein the at least one regulating element is a shut-off flap.

19. The water tank as claimed in claim 10, the water tank being for a motor vehicle as claimed in claim 1.

20. The water tank as claimed in claim 13, wherein the heat-reflecting foil surrounds the first inner chamber substantially completely.

21. The method as claimed in claim 14, the method being for controlling the temperature of a motor vehicle, comprising:
a water tank with a first inner chamber for separating and removing water from a first air stream flowing through the first inner chamber, wherein the water tank-is designed as a heat exchanger and has a heat exchange element which serves for transferring thermal energy between the first air stream and a second air stream; and
at least one guide structure-, which serves for guiding the second air stream to the heat exchange element in a targeted manner;
wherein at least one control element is provided, by way of which the transfer of the thermal energy between the first air stream and the second air stream can be allowed in a first operating state and at least partially prevented in a second operating state.

22. The method as claimed in claim 14, the vehicle having a water tank comprising:
a first inner chamber for separating and removing water from a first air stream flowing through the first inner chamber;
a heat exchange element, which serves for transferring thermal energy between the first air stream and a second air stream; and
at least one guide structure, which serves for guiding the second air stream to the heat exchange element in a targeted manner;
wherein the water tank comprises at least one control element, by way of which the transfer of the thermal energy between the first air stream and the second air stream can be allowed in a first operating state and at least partially prevented in a second operating state.
